(19) United States
(12) Patent Application Publication
(10) Pub. No.: US 2012/0113761 A1
(43) Pub. Date: May 10, 2012

(54) MEDICINE REMINDER DEVICE

(76) Inventors: Ming-Fu Chen, Taipei (TW); Cheng-Hsiung Chen, Taipei (TW)

(21) Appl. No.: 12/941,476

(22) Filed: Nov. 8, 2010

(51) Int. Cl. G04B 47/00

(52) U.S. Cl. 368/10

(57) ABSTRACT

A medicine reminder device includes a housing, a processing unit, a schedule-setting input unit, a timing unit, light emitting units and medicine containing units. The schedule-setting input unit, the timing unit and the light emitting units are coupled to the processing unit. Each of the medicine containing units corresponds to at least one of the light emitting units, such that at least a part of light, emitted from the light emitting unit, enters the medicine containing unit and then transmits to the outside. The processing unit receives a schedule-setting event through the schedule-setting input unit to obtain timing information. The timing unit receives the timing information and executes a timing event. The processing unit outputs a control signal according to a result resulting from execution of the timing unit, and enables at least one of the light emitting units according to the control signal.

### BACKGROUND OF THE INVENTION

1. Field of Invention

The invention relates to a medicine reminder device.

2. Related Art

Correctly taking medicines on time is the only way to the disease curing. Medicine boxes available in the market usually have compartments such that the user can distinguish between medicines to be taken at different predetermined times and cannot get confused. However, the medicine box has to be used under the precondition that the user has the clear self-awareness. If the user cannot pay attention to the predetermined medicine taking time and the predetermined medicine time has elapsed, the curing effect of the medicine still can be affected, and the recovering timing is delayed. In addition, the lapse of medicine taking may further increase the loading of the body of the user, particularly the chronic patient, the old person and the like who has to take a lot of medicines for a long time. Thus, the medicine box has to be carefully selected.

The prior art has disclosed a medicine box with the warning function. FIG. 1 is a schematic illustration showing a conventional medicine box 1 with the warning function. Referring to FIG. 1, the medicine box 1 includes a housing 11, a plurality of medicine containing units 12 and a control module 13. The medicines are placed and saved in the medicine containing units 12. The control module 13 has a setting unit 131, a display unit 132 and an audio unit 133. The user can set the predetermined medicine taking times through the setting unit 131, and the corresponding time information can be displayed on the display unit 132. When the predetermined medicine taking time is up, the audio unit 133 outputs a sound to remind the user.

However, the conventional medicine box with the warning function cannot achieve the reminding effect unless the medicine taking time is manually inputted in advance. The old person or the individual with disability cannot set the predetermined medicine taking time by himself or herself when the family travels or cannot take care of the old person or the individual with disability therearound. Meanwhile, the family cannot truly obtain whether the user takes the medicines in time, and the physiological state when or after the medicines are taken.

Thus, it is an important subject to provide a medicine reminder device capable of reminding the user of the medicine taking time. In addition, the caretaker, instead of the user, can remotely operate the medicine reminder device to set the medicine taking time. In addition, the medicine reminder device further has the function of confirming the user's physiological state.

### SUMMARY OF THE INVENTION

In view of the foregoing, an objective of the invention is to provide a medicine reminder device, which can receive remote information to set the medicine taking time, and remind the user to take the medicines in time based on the set data content. In addition, this device can further notify the remote object of the user's medicine taking condition through the data transmission.

Another objective of the invention is to provide a medicine reminder device having the medicine containing portion integrated with the display function of the operation interface, so that the element material is saved and the product size is reduced. Most important of all, a man-machine interface for facilitating the recognition of the set information is provided and may be used by the senior or the person with the poor physiological condition.

Still another objective of the invention is to provide a medicine reminder device having the element structure integrated with the simple physiological testing mechanism, so that the user's physical and mental states can be quickly tested at the specific time and/or after the medicines are taken, and the system of assisting in handling the health information can be obtained.

To achieve the above objectives, the invention discloses a medicine reminder device including a housing, a processing unit, a schedule-setting input unit, a timing unit, a plurality of light emitting units and a plurality of medicine containing units. The processing unit is accommodated within the housing. The schedule-setting input unit is disposed in the housing and coupled to the processing unit. The timing unit is accommodated within the housing and coupled to the processing unit. The light emitting units are disposed in the housing and coupled to the processing unit. The medicine containing units are disposed in the housing. Each of the medicine containing units corresponds to at least one of the light emitting units, such that at least a part of light emitted from the light emitting unit enters the medicine containing unit and then transmits to the outside. The processing unit receives a schedule-setting event through the schedule-setting input unit to obtain timing information, the timing unit receives the timing information and executes a timing event, and the processing unit outputs a control signal according to a result resulting from execution of the timing unit and controls at least one of the light emitting units to emit light according to the control signal.

In one embodiment of the invention, the schedule-setting input unit is a manual operation interface having a plurality of keys. Preferably, the manual operation interface is a physical key or a touch panel.

In one embodiment of the invention, the processing unit receives the schedule-setting event to obtain schedule information, and controls at least one of the light emitting units to emit the light according to the schedule information.

In one embodiment of the invention, the content of the schedule information includes schedule data and value data. Thus, the processing unit can control at least one of the light emitting units to emit the light according to the schedule data. In addition, the processing unit can also control at least one of the light emitting units to emit the light according to the value data, and the number of light emitting units emitting the light corresponds to the value data.

In one embodiment of the invention, the schedule-setting input unit includes a wired signal receiving unit, a wireless signal receiving unit or a combination of the wired and wireless signal receiving units for receiving the schedule-setting event, inputted by a user input, through a wired connection and/or wireless signal transmission. Preferably, a user may input the schedule-setting event through an electronic device or a portable communication device, and provide the schedule-setting event to the schedule-setting input unit in the form of a text file, a sound, an E-mail or a short message. Herein, the electronic device is a computer or a wired telephone, and the portable communication device is a mobile phone, a personal digital assistant or a navigator.

In one embodiment of the invention, the medicine reminder device further includes a storage unit and a signal transmission unit. The storage unit is accommodated within the housing and coupled to the processing unit, and it records user's medicine taking information. The signal transmission unit is coupled to the processing unit, and transmits the user's medicine taking information to another electronic device. Preferably, the signal transmission unit transmits the user's medicine taking information through a wired connection and/or wireless signal transmission. Herein, the signal transmission unit transmits the user's medicine taking information in the form of a text file, a sound, an E-mail or a short message.

In one embodiment of the invention, the medicine reminder device further includes an audio unit and a verification unit. The audio unit is coupled to the processing unit. The processing unit outputs an audio signal according to the result resulting from the execution of the timing unit, and controls the audio unit to output a sound. The verification unit is coupled to the processing unit. Herein, a user inputs a verification event through the verification unit to provide a verification signal to the processing unit, and the processing unit stops the light emitting units from emitting the light and/or stops the audio unit from outputting the sound according to the verification signal.

In one embodiment of the invention, the medicine reminder device further includes an interaction unit and a notification unit. The interaction unit disposed in the housing and coupled to the processing unit, and the notification unit is coupled to the processing unit. Herein, the processing unit controls at least one of the light emitting units to emit the light according to test data. A user inputs an interaction event on the interaction unit according to the number of the light emitting units to provide interaction data to the processing unit, and the processing unit obtains awareness and/or physiological state data according to the test data and the interaction data. The notification unit transmits the awareness and/or physiological state data to another electronic device through a wired connection and/or wireless signal transmission. Moreover, the processing unit controls the number of the light emitting units, which emit the light, and/or light emitting levels of the light emitting units according to the test data.

In one embodiment of the invention, the light emitting units include light-emitting diodes.

In one embodiment of the invention, the medicine containing units are partially or fully integrally formed.

As mentioned above, the medicine reminder device according to the invention has the schedule-setting input unit for the user to set the medicine taking time, and also has the timing unit and the light emitting unit. So, the medicine reminder device can emit light to reminder the user to take the medicines at the predetermined time. More particularly, the light emitting position corresponds to the medicine containing unit containing the medicines to be taken, and can prevent the user from getting confused in taking the medicines.

The medicine taking schedule can be set manually as well as by receiving the data in the wired and/or wireless manner, so that the remote operator, instead of the user, can set the medicine taking times through the computer or mobile phone. Thus, a convenient function, which can reduce the errors and cannot be restricted by the distance, can be provided to the senior or the individual with disability when the family travels or cannot take care of the senior or the individual with disability therearound.

When the user is inputting the schedule-setting event, a pattern constituted by multiple light emitting units emitting light may be adopted instead of the conventional digital frame, and thus can be easily understood and can ease the senior of the difficulty of reading the digital display. Thus, the invention satisfies the design of the human-oriented interface. Meanwhile, since the display portion and the medicine containing portion are integrated together, the element material can be further saved, and the product size can be reduced.

In addition, the medicine reminder device of the invention is adapted to be combined with the storage unit for recording the user's medicine taking conditions, which can be transmitted back to the mobile electronic device of the medical staff or caretaker through the signal transmission unit, so that the associated person can momentarily and truly obtain the user's treatment progresses and conditions. When the interaction unit is incorporated, it is further possible to achieve the function of actively testing the awareness and physiological state of the user when or after the user takes the medicines. Thus, the user still can have the sufficient and timely care without being monitored in actions.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional medicine box with the warning function;

FIG. 2 is a schematic illustration showing a medicine reminder device according to a first preferred embodiment of the invention;

FIG. 3 is a system block diagram showing the medicine reminder device of FIG. 2;

FIG. 4 is a schematic illustration showing a medicine reminder device according to one aspect of a second preferred embodiment of the invention;

FIG. 5 is a schematic illustration showing a medicine reminder device according to another aspect of the second preferred embodiment of the invention;

FIGS. 6A and 6B are schematic illustrations showing schedule-setting operations of a medicine reminder device according to different aspects of the embodiment of the invention;

FIG. 7A is a schematic illustration showing a medicine reminder device according to a third preferred embodiment of the invention; and

FIG. 7B is a system block diagram showing the medicine reminder device of FIG. 7A.

### DETAILED DESCRIPTION OF THE INVENTION

The present invention will be apparent from the following detailed description, which proceeds with reference to the accompanying drawings, wherein the same references relate to the same elements.

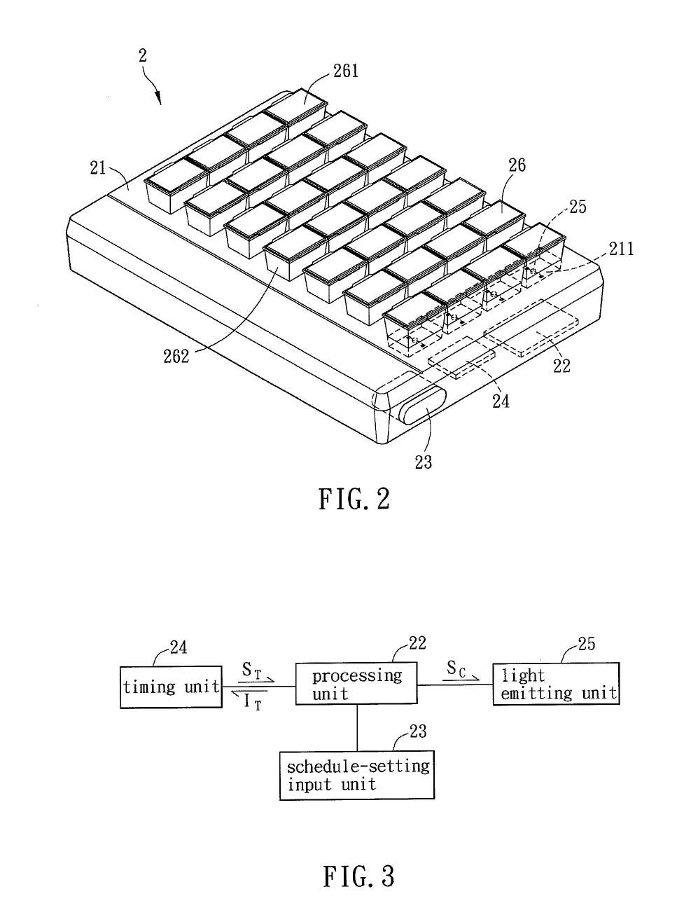

FIG. 2 is a schematic illustration showing a medicine reminder device 2 according to a first preferred embodiment of the invention. Referring to FIG. 2, the medicine reminder device 2 of this embodiment includes a housing 21, a processing unit 22, a schedule-setting input unit 23, a timing unit 24, a plurality of light emitting units 25 and a plurality of medicine containing units 26. In this embodiment, the schedule-setting input unit 23 is disposed on one side of the housing 21, and partially exposed out of the housing 21. The housing 21 has a plurality of concave portions 211 each corresponding to one of the light emitting units 25, above which the medicine containing unit 26 is disposed.

In detail, the light emitting unit 25 is disposed in the housing 21 with it being partially exposed out of a side surface of the concave portion 211 of the housing 21, and its exposed portion is preferably the light emitting portion. The medicine containing unit 26 is disposed in the concave portion 211 and stacked above the light emitting unit 25. The medicine containing unit 26 may be disposed in a non-restrictive manner, and may be detachably engaged with the housing 21 or fixedly adhered to the housing 21.

According to the above-mentioned arrangement relationship in conjunction with the feature that the medicine containing unit 26 is preferably made of a light-permeable material, the light emitted from the specific light emitting unit 25 partially enters the medicine containing unit 26 from its light emitting portion, and then transmits to the corresponding medicine containing unit 26. Thus, the user's visual feeling recognizes that the specific medicine containing unit 26 is emitting the light and can be distinguished from other light emitting units that do not emit the light.

However, the arrangement relationships between the above-mentioned elements are only proposed for the illustrative but non-restrictive purpose. In addition, any arrangement or connection relationship that can make the light of the light emitting unit 25 enter the medicine containing unit 26 to generate the visual light emitting effect may be still deemed as falling within the scope of the invention. For example, the light emitting unit 25 may also be disposed on the sidewall of the concave portion 211 of the housing 21, and the light can enter the medicine containing unit 26 from the sidewall of the medicine containing unit 26. Alternatively, the housing 21 may be light-permeable or partially light-permeable such that the light can partially enter the medicine containing unit 26 although the light emitting unit 25 is embedded into the housing 21. In addition, it is unnecessary to provide one medicine containing unit 26 corresponding to one light emitting unit 25. Instead, multiple light emitting units 25 may be disposed below one medicine containing unit 26.

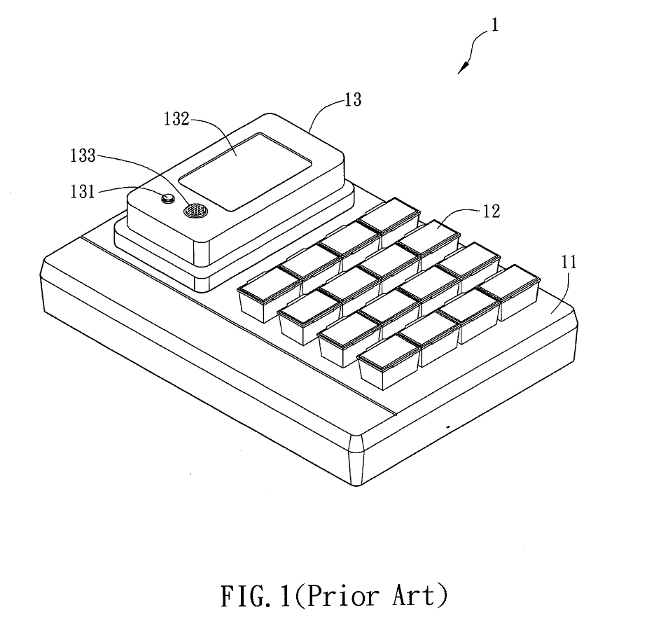

The medicine containing units 26 accommodate to-be-taken medicines, and the number of medicines is not particularly restricted and is preferably equal to 28 (see FIG. 1), which corresponds to the product of 4 (four times a day) and 7 (seven days a week), wherein the four times include the times near three meals and the time before sleep, and the medicines are sequentially arranged from left to right or from right to left. For example, the first medicine containing unit 261 in the first row represents the Monday morning, while the fourth medicine containing unit 262 in the fourth row represents the time before sleep on Thursday, and so on. The medicine containing units 26 may be independently separated, or partially or fully integrally formed. As shown in FIG. 1, four medicine containing units 26 constituting one set are integrally formed in this embodiment. However, the four medicine containing units 26 still can be individually opened.

FIG. 3 is a system block diagram showing the medicine reminder device of FIG. 2. Referring to FIG. 3, the schedule-setting input unit 23, the timing unit 24 and the light emitting unit 25 are coupled to the processing unit 22. In this embodiment, the coupling represents the electrical connection so that the signals can be transmitted between different units. The processing unit 22 may be a micro-chip or a microprocessor. The schedule-setting input unit 23 serves as an element capable of converting an external operation action of the user into the internal control signal to activate the subsequent executing function. Therefore, the schedule-setting input unit 23 is preferably a manual operation interface or a signal receiving unit, and partially exposed out of the surface of the housing 21. The manual operation interface may have physical keys or virtual keys formed on the touch panel so that the user can directly press the keys for operation. However, the invention is not particularly limited thereto. The signal receiving unit may be a wired signal receiving unit, a wireless signal receiving unit or a combination thereof, so that the user can make the setting remotely through the wired connection and/or the wireless signal transmission. More specifically, the wired signal receiving unit and the wireless signal receiving unit may be an Ethernet circuit interface and a wireless network circuit interface, respectively.

The timing unit 24 may be, for example, an element made according to the principle of the typical electronic clock, and mainly includes an oscillator for outputting pulse signals serving as the timing bases. Regarding the timing method of the timing unit 24, it is possible to calculate how much time elapses or how much time is left. In other words, the invention is not restricted to the time countup or time countdown. The light emitting unit 25 may include a light emitting diode or any other element capable of outputting the visible light.

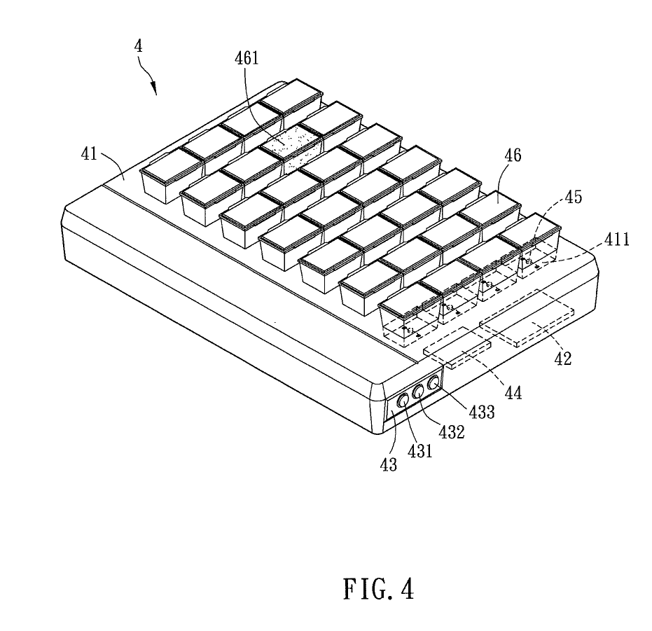

The method of setting the medicine taking schedule of the invention will be described with reference to the signal transmission of FIG. 3. FIG. 4 is a schematic illustration showing a medicine reminder device 4 according to one aspect of a second preferred embodiment of the invention. Referring to FIG. 4, the structure and technological feature of the medicine reminder device 4 of this embodiment are substantially the same as those of the first embodiment (e.g., the housing 41 and the medicine containing unit 46 are the same as those mentioned hereinabove) except that the schedule-setting input unit 43 is a manual operation interface having a plurality of physical keys 431 to 433 to be pressed by the user for input. Thus, the processing unit 42 can receive a schedule-setting event to output timing information I_{T}. Next, the timing unit 44 receives the timing information I_{T} and executes a timing event. The timing unit 44 obtains and outputs a timing signal S_{T} according to the execution result. Then, the processing unit 42 outputs a control signal S_{C} according to the timing signal S_{T}, and controls at least one of the light emitting units 45 to emit light according to the control signal S_{C}.

Accordingly, when the user wants to set the information of taking medicines at 12 o'clock at Tuesday noon, for example, the processing unit 42 receives the input event and then outputs the timing information I_{T} to the timing unit 44. When the timing unit 44 counts the time to 12 o'clock at the Tuesday noon, it outputs the timing signal S_{T}, so that the processing unit 42 outputs the control signal S_{C} according to the timing signal S_{T}, and controls the light emitting unit 45, corresponding to Tuesday noon, to emit light (the effect is shown as the medicine containing unit 461 in FIG. 4) and to achieve the object of reminding the user to take the medicines in the medicine containing unit 461.

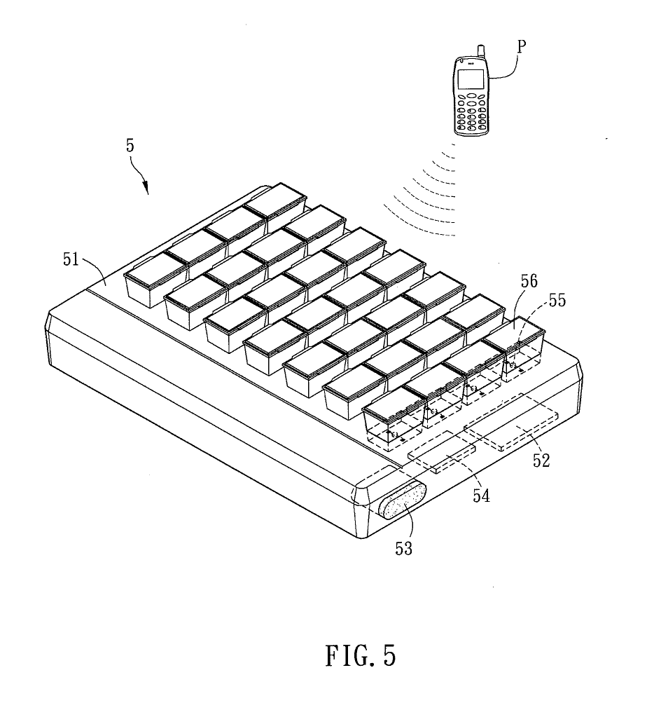

FIG. 5 is a schematic illustration showing a medicine reminder device 5 according to another aspect of the second preferred embodiment of the invention. As shown in FIG. 5, the medicine reminder device 5 according to this aspect of the embodiment is almost the same as that of the above-mentioned embodiment (e.g., the housing 51, the timing unit 54, the light emitting unit 55 and the medicine containing unit 56 are the same as those mentioned hereinabove) except that the schedule-setting input unit 53 is a wireless network circuit interface for receiving the schedule-setting event inputted by a user on an electronic device or a portable communication device (e.g., the mobile phone P of FIG. 5) through the wireless signal transmission. The schedule-setting event can be provided to the schedule-setting input unit 53 in the form of a text file, a sound, an E-mail, a short message or the like, and the processing unit 52 may make the judgment according to the text code recognition technology or the audio content recognition technology to read the timing information contained therein. The electronic device may be, for example, a computer or a wired telephone, and the portable communication device may be additionally a personal digital assistant or a portable navigator. However, the invention is not particularly restricted thereto.

Thus, the medicine reminder device of the invention allows the user to input the time of taking the medicines directly or remotely, and thus can emit light to remind the user to take the medicines according to the set schedule. More particularly, the light emitting position corresponds to the medicine containing unit, containing the medicines to be taken, to prevent the user from getting confused.

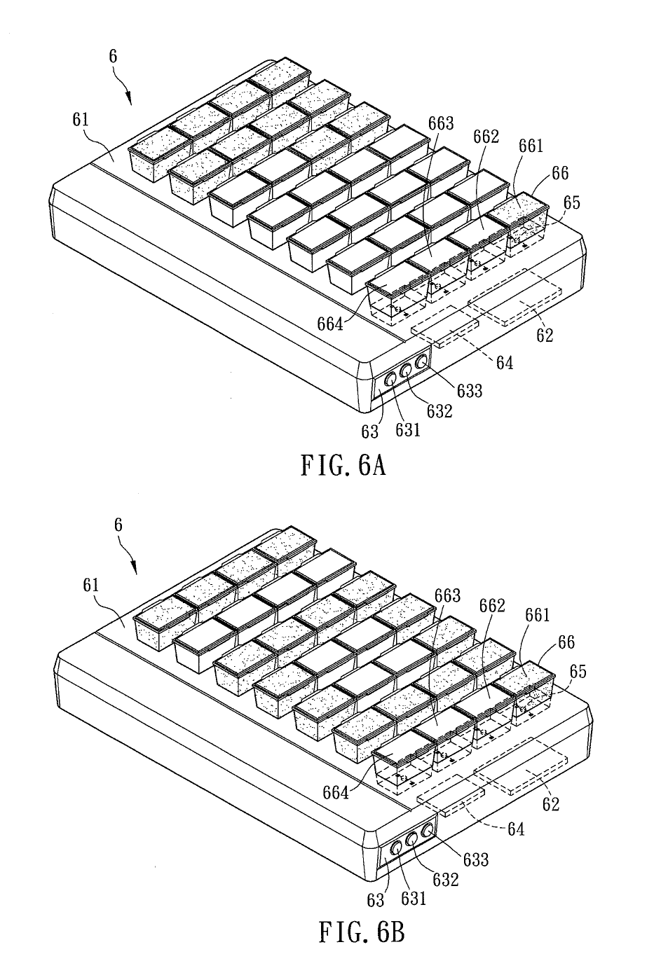

According to the above-mentioned content, it is obtained that the medicine containing units may correspond to the number of times of taking the medicines a week. Based on this property, the invention additionally provides a novel schedule-setting representing method. FIGS. 6A and 6B are schematic illustrations showing schedule-setting operations of a medicine reminder device 6 according to different aspects of the embodiment of the invention. Referring first to FIG. 6A, the medicine reminder device 6 has a housing 61. In this embodiment, there are 28 medicine containing units 66 of the medicine reminder device 6, and each medicine containing unit 66 is provided with at least one light emitting unit 65. The foremost four medicine containing units 661 to 664 may respectively represent the schedules of the user in one day, including those in the morning, at the noon, in the evening and before sleep, by way of software configuration. The other 24 medicine containing units 66 respectively represent 24 hours a day.

In this embodiment, the schedule-setting event firstly performs the schedule setting and then the timing setting. In detail, the user presses the schedule-setting input unit 63 to make the processing unit 62 receive the schedule-setting event and obtain schedule information. The schedule information includes two portions corresponding to schedule data and value data. The content of the schedule data includes in the morning, at the noon, in the evening or before sleep, while the content of the value data includes any integer between 1 and 24. Thus, the combination of the two portions can set the schedule of taking the medicines to a particular time instant pertaining to a particular schedule time interval.

The schedule data and the value data may be simultaneously or sequentially inputted through different keys, and the invention is not particularly restricted thereto. For example, the key 631 may be utilized to input the schedule data, and the four schedules may be switched according to the number of times of pressing the key, such that the processing unit 62 controls at least one of the light emitting units 65 to emit light according to the schedule data. In addition, the key 632 may be utilized to input the value data, and the input value may be represented according to the number of times of pressing the key, such that the processing unit 62 controls at least one of the light emitting units 65 to emit the light according to the value data, wherein the number of the light emitting units 65 emitting the light corresponds to the value data. The key 633 may serve as a verification key to verify the input content.

For example, when the user wants to set the time of taking the medicines at ten o'clock in the morning and presses the key 631 once and the key 632 ten times, the light emitting unit 65 is controlled to make the medicine containing unit 661 emit light, which represents that the time interval of the set schedule is in the morning. In addition, ten medicine containing units 66 on the other side may also emit the light (see the black portion in the drawing) to correspond to the ten o'clock. Thus, the user can indeed realize whether the set time instant is correct.

In this embodiment, the light is emitted sequentially from the rear side to the bottom side and the front side to correspond to the number of times of pressing the key by the user. In other aspect, however, a different representation may be adopted. For example, the light may be emitted from the right side to the bottom side and then to the left side. Similarly, it is also possible to utilize the 24 medicine containing units 66 to set predetermined time instants of taking the medicines within 24 hours a day without setting the schedule time interval.

Referring again to FIG. 6B, in another aspect of the invention, the light emitting units 65 forms a light emitting pattern corresponding to the inputted value data. For example, in the same schedule information, the light emitting medicine containing units 66 constitute the pattern similar to the number of “10” to achieve the object of setting the time to 10 o'clock.

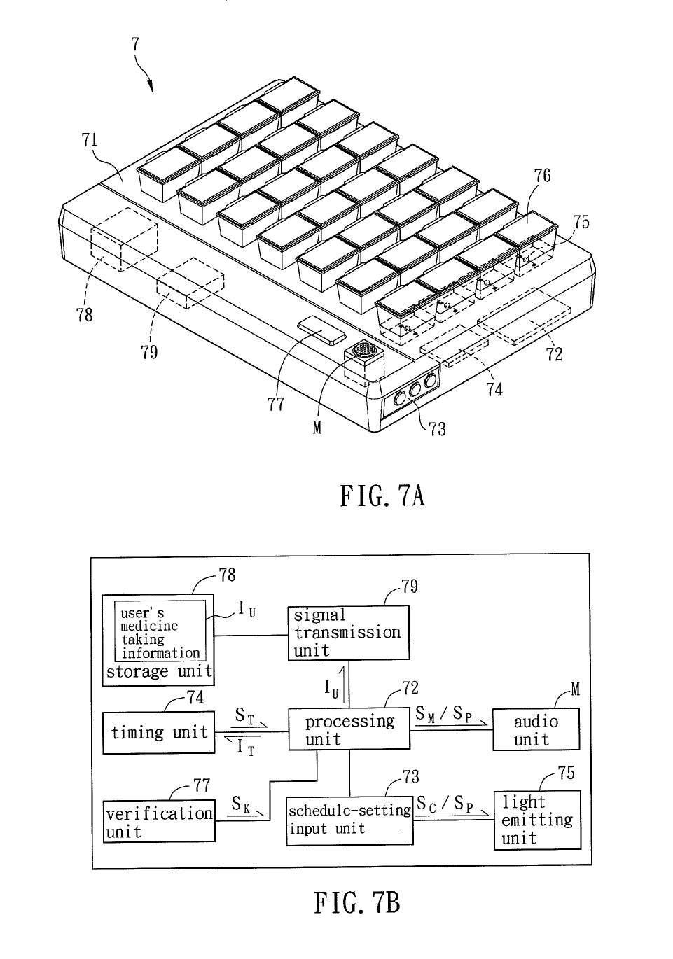

FIG. 7A is a schematic illustration showing a medicine reminder device 7 according to a third preferred embodiment of the invention. FIG. 7B is a system block diagram showing the medicine reminder device 7 of FIG. 7A. Referring to FIGS. 7A and 7B, the element structures and the technological features of the medicine reminder device 7 in this embodiment are substantially the same as those of the embodiment except that an audio unit M, a verification unit 77, a storage unit 78 and a signal transmission unit 79 are further provided. The audio unit M, the verification unit 77, the storage unit 78 and the signal transmission unit 79 are coupled to a processing unit 72. In this embodiment, the coupling represents the electrical connection which facilitates the signal transmission or data transmission. The audio unit M and the verification unit 77 are respectively partially exposed out of the surface of a housing 71, while the storage unit 78 and the signal transmission unit 79 are accommodated within the housing 71. In this embodiment, the exposed portion of the audio unit M is a speaker, while the exposed portion of the verification unit 77 is a key.

The timing unit 74 receives the timing information I_{T} and executes a timing event. The timing unit 74 obtains and outputs a timing signal S_{T} according to the result of executing the timing event. Then, the processing unit 22 outputs an audio signal S_{M} according to the timing signal S_{T}, and controls the audio unit M to output the sound according to the audio signal S_{M}. When the medicine reminder device 7 outputs light and sound due to that the set time of taking the medicines is up, the user can input a verification event by pressing the verification unit 77 to provide a verification signal S_{K} to the processing unit 72, and the processing unit 72 simultaneously or respectively outputs the stopping signal Sp to the light emitting unit 75 and the audio unit M according to the verification signal S_{K} to stop the light emitting unit 75 from emitting the light and/or stop the audio unit M from outputting the sound. The outputted sound may be, for example, the human's voice, the remind sound or the pre-recorded content.

In this embodiment, if the user is not indeed reminded to complete the operation of taking the medicines at the set time, the medicine reminder device 7 also stops emitting the light and outputting the sound after a period of time, but the processing unit 72 generates the statistical information that the medicines are not taken on time and records the statistical information in the storage unit 78 to serve as one set of the user's medicine taking information I_{U}.

Referring again to FIGS. 7A and 7B simultaneously, since the medicine reminder device 7 has the signal transmission unit 79, it can transmit the user's medicine taking information I_{U} to the other electronic device of the remote object in time or after a period of time so that the medical staff or relatives can obtain the user's medicine taking condition. The information transmission may be achieved by way of wired connection and/or wireless signal transmission. In this embodiment, the signal transmission unit 79 utilizes the mobile communication system network (i.e., the mobile phone network) to transmit, through the wireless signal, the user's medicine taking information I_{U} to the mobile phone of the remote object in the form of the text file, a sound, an E-mail or short message.

As shown in FIG. 7A, the signal transmission unit 79 and the schedule-setting input unit 73 are separated elements in this embodiment. In other aspects of this embodiment, however, both of them can be integrated into a single input/output module to handle the data input and output. However, the invention is not limited thereto.

In addition, in another preferred embodiment of the invention, the medicine reminder device further includes an interaction unit and a notification unit. Similarly, the interaction unit may be disposed in the housing with a key portion exposed out of the housing. The interaction unit is coupled to the processing unit and is preferably electrically connected to the processing unit. When the processing unit controls at least one of the light emitting units to emit light according to the test data, stored in the storage unit, for example, the user can judge the number of light emitting units, which emit light, and/or the meanings represented by the positions of the light emitting units according to his/her self-awareness. The processing unit controls the number of the light emitting units, which emit the light, and/or the light emitting levels of the light emitting units to serve as different tests according to the content of the test data.

For example, 10 light emitting units, which emit light, represent 10 o'clock, and the upper left corner, which emits light, represents the morning. Next, the user inputs an interaction event on the interaction unit (e.g., presses one key or multiple keys on the interaction unit) according to the number of the light emitting units to provide interaction data to the processing unit. Thereafter, the processing unit can compare the content of the test data with the result of the interaction data, and thus judge the user's awareness and/or the physiological state to obtain the awareness and/or physiological state data.

After the user's awareness and/or physiological state data are obtained, the medicine reminder device may further utilize the notification unit to transmit the awareness and/or physiological state data to another electronic device through the wired connection and/or wireless signal transmission, so that the medical staff or family can obtain the user's condition. The technological content of the notification unit is similar to that of the schedule-setting input unit or the signal transmission unit, has been mentioned hereinabove, and will be omitted here.

To sum up, the medicine reminder device according to the invention has the schedule-setting input unit for the user to set the medicine taking time, and also has the timing unit and the light emitting unit. So, the medicine reminder device can emit light to reminder the user to take the medicines at the predetermined time. More particularly, the light emitting position corresponds to the medicine containing unit containing the medicines to be taken, and can prevent the user from getting confused in taking the medicines.

The medicine taking schedule can be set manually as well as by receiving the data in the wired and/or wireless manner, so that the remote operator, instead of the user, can set the medicine taking times through the computer or mobile phone. Thus, a convenient function, which can reduce the errors and cannot be restricted by the distance, can be provided to the senior or the individual with disability when the family travels or cannot take care of the senior or the individual with disability therearound.

When the user is inputting the schedule-setting event, a pattern constituted by multiple light emitting units emitting light may be adopted instead of the conventional digital frame, and thus can be easily understood and can ease the senior of the difficulty of reading the digital display. Thus, the invention satisfies the design of the human-oriented interface. Meanwhile, since the display portion and the medicine containing portion are integrated together, the element material can be further saved, and the product size can be reduced.

In addition, the medicine reminder device of the invention is adapted to be combined with the storage unit for recording the user's medicine taking conditions, which can be transmitted back to the mobile electronic device of the medical staff or caretaker through the signal transmission unit, so that the associated person can momentarily and truly obtain the user's treatment progresses and conditions. When the interaction unit is incorporated, it is further possible to achieve the function of actively testing the awareness and physiological state of the user when or after the user takes the medicines. Thus, the user still can have the sufficient and timely care without being monitored in actions.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A medicine reminder device, comprising:
a housing;
a processing unit accommodated within the housing;
a schedule-setting input unit disposed in the housing and coupled to the processing unit;
a timing unit accommodated within the housing and coupled to the processing unit;
a plurality of light emitting units disposed in the housing and coupled to the processing unit; and
a plurality of medicine containing units disposed in the housing, wherein each of the medicine containing units corresponds to at least one of the light emitting units, such that at least a part of light emitted from the light emitting unit enters the medicine containing unit and then transmits to the outside,
wherein the processing unit receives a schedule-setting event through the schedule-setting input unit to obtain timing information, the timing unit receives the timing information and executes a timing event, and the processing unit outputs a control signal according to a result resulting from execution of the timing unit and controls at least one of the light emitting units to emit light according to the control signal.

2. The medicine reminder device according to claim 1, wherein the schedule-setting input unit is a manual operation interface having a plurality of keys.

3. The medicine reminder device according to claim 2, wherein the manual operation interface comprises a physical key or a touch panel.

4. The medicine reminder device according to claim 1, wherein the processing unit receives the schedule-setting event to obtain schedule information, and controls at least one of the light emitting units to emit the light according to the schedule information.

5. The medicine reminder device according to claim 4, wherein a content of the schedule information comprises schedule data, and the processing unit controls at least one of the light emitting units to emit the light according to the schedule data.

6. The medicine reminder device according to claim 4, wherein a content of the schedule information comprises value data, the processing unit controls at least one of the light emitting units to emit the light according to the value data, and the number of light emitting units emitting the light corresponds to the value data.

7. The medicine reminder device according to claim 1, wherein the schedule-setting input unit comprises a wired signal receiving unit, a wireless signal receiving unit or a combination of the wired and wireless signal receiving units for receiving the schedule-setting event, inputted by a user input, through a wired connection and/or wireless signal transmission.

8. The medicine reminder device according to claim 7, wherein a user inputs the schedule-setting event through an electronic device or a portable communication device, and provides the schedule-setting event to the schedule-setting input unit in the form of a text file, a sound, an E-mail or a short message.

9. The medicine reminder device according to claim 8, wherein the electronic device is a computer or a wired telephone, and the portable communication device is a mobile phone, a personal digital assistant or a navigator.

10. The medicine reminder device according to claim 1, further comprising:
a storage unit accommodated within the housing and coupled to the processing unit, wherein the storage unit records user's medicine taking information.

11. The medicine reminder device according to claim 10, further comprising:
a signal transmission unit coupled to the processing unit, wherein the signal transmission unit transmits the user's medicine taking information to another electronic device.

12. The medicine reminder device according to claim 11, wherein the signal transmission unit transmits the user's medicine taking information through a wired connection and/or wireless signal transmission.

13. The medicine reminder device according to claim 12, wherein the signal transmission unit transmits the user's medicine taking information in the form of a text file, a sound, an E-mail or a short message.

14. The medicine reminder device according to claim 1, further comprising:
an audio unit coupled to the processing unit, wherein the processing unit outputs an audio signal according to the result resulting from the execution of the timing unit, and controls the audio unit to output a sound.

15. The medicine reminder device according to claim 14, further comprising:
a verification unit coupled to the processing unit, wherein a user inputs a verification event through the verification unit to provide a verification signal to the processing unit, and the processing unit stops the light emitting units from emitting the light and/or stops the audio unit from outputting the sound according to the verification signal.

16. The medicine reminder device according to claim 1, further comprising:
an interaction unit disposed in the housing and coupled to the processing unit, wherein the processing unit controls at least one of the light emitting units to emit the light according to test data, a user inputs an interaction event on the interaction unit according to the number of the light emitting units to provide interaction data to the processing unit, and the processing unit obtains awareness and/or physiological state data according to the test data and the interaction data.

17. The medicine reminder device according to claim 16, further comprising:
a notification unit, coupled to the processing unit, for transmitting the awareness and/or physiological state data to another electronic device through a wired connection and/or wireless signal transmission.

18. The medicine reminder device according to claim 16, wherein the processing unit controls the number of the light emitting units, which emit the light, and/or light emitting levels of the light emitting units according to the test data.

19. The medicine reminder device according to claim 1, wherein the light emitting units comprise light-emitting diodes.

20. The medicine reminder device according to claim 1, wherein the medicine containing units are partially or fully integrally formed.
